(19) United States
(12) Patent Application Publication
(10) Pub. No.: US 2017/0344523 A1
(43) Pub. Date: Nov. 30, 2017

(54) METHOD AND APPARATUS FOR PRESENTATION CUSTOMIZATION AND INTERACTIVITY

(71) Applicant: Samsung Electronics Co., Ltd, Suwon-si (KR)

(72) Inventors: Imed Bouazizi, Plano, TX (US); Kyungmo Park, Seoul (KR)

(21) Appl. No.: 15/465,424

(22) Filed: Mar. 21, 2017

Related U.S. Application Data
(60) Provisional application No. 62/341,352, filed on May 25, 2016.

(51) Int. Cl. G06F 17/22; G06F 17/21; G06F 17/30

(52) U.S. Cl. CPC G06F 17/2247; G06F 17/30353; G06F 17/212; G06F 17/30268

(57) ABSTRACT

A user equipment (UE) for reproducing a presentation having a plurality of media includes a processor, a memory, and a display. The processor receives a first document configured to provide a presentation and a second document configured to indicate a timing sequence for media and spatial layout updates. The processor determines whether the second document includes at least one condition for at least one instruction element among the plurality of instructions and reproduces the plurality of instructions in accordance with the first document, the second document, and/or the at least one condition. The memory stores at least one media based on a store directive when the second document includes a store directive for at least one instruction among the plurality of instructions. The display displays the reproduced plurality of media.

### CROSS-REFERENCE TO RELATED APPLICATION AND CLAIM OF PRIORITY

This application claims priority under 35 U.S.C. §119(e) to U.S. Provisional Patent Application No. 62/341,352 filed on May 25, 2016. The above-identified provisional patent application is hereby incorporated by reference in its entirety.

### TECHNICAL FIELD

This disclosure relates generally to media presentations. More specifically, this disclosure relates to a method and apparatus for customizing media presentations and adjusting media content transmission schedules.

### BACKGROUND

Recently, presentations viewed by users are becoming interactive. Such presentations are reproduced based on Motion Picture Experts Group (MPEG) Composition Information (CI). The MPEG CI provides timed instructions to control the presentation and synchronize the various components. With the advances in multimedia services, more interactivity and customization are becoming normal. The way a user experiences content may be different from the way another user experiences the same content. The MPEG CI needs to support different playback orders based on a user profile and interactivity. The delivery server must also be able to support the different user experiences by ensuring that data is available when it needs to be presented to the user.

### SUMMARY

This disclosure provides a method and apparatus for presentation customization and interactivity.

In a first embodiment, user equipment (UE) for reproducing a presentation having a plurality of media a processor, a memory, and a display. The processor receives a first document configured to provide a presentation and a second document configured to indicate a timing sequence for media and spatial layout updates. The processor determines whether the second document includes at least one condition for at least one instruction element among the plurality of instructions and reproduces the plurality of instructions in accordance with the first document, the second document, and/or the at least one condition. The memory stores at least one media based on a store directive when the second document includes a store directive for at least one instruction among the plurality of instructions. The display displays the reproduced plurality of media.

In a second embodiment, a server includes a processor and a transceiver. The processor is configured to generate a first document configured to provide a presentation and at least one second document including at least one condition for at least one instruction element for a media element. The transceiver is configured to transmit the first document and the second document to a user equipment (UE). The second document includes a time associated with the at least at least one instruction where the time provides an indication of the earliest time that the media element may be reproduced.

In a third embodiment, a method for reproducing a presentation in an electronic device having a processor and a display includes receiving, in the processor, a first document configured provide the presentation and a second document configured to indicate a timing sequence for a plurality of media and spatial layout updates included in the presentation. The method also includes determining whether the second document includes at least one condition for at least one instruction element among a plurality of instructions and reproducing, by the processor, the plurality of instructions in accordance with the first document, the second document, and/or the at least one condition. The presentation is displayed according to the reproduced plurality of instructions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example computing system according to this disclosure;

FIGS. 2 and 3 illustrate example devices in a computing system according to this disclosure;

FIG. 4 illustrates is system for processing presentation information according to this disclosure;

FIG. 5 illustrates different scenarios for reproducing presentation information according to this disclosure;

FIG. 6 illustrates a method for processing presentation information according to this disclosure; and

FIG. 7 illustrates a method for reproducing media sync elements according to this disclosure.

### DETAILED DESCRIPTION

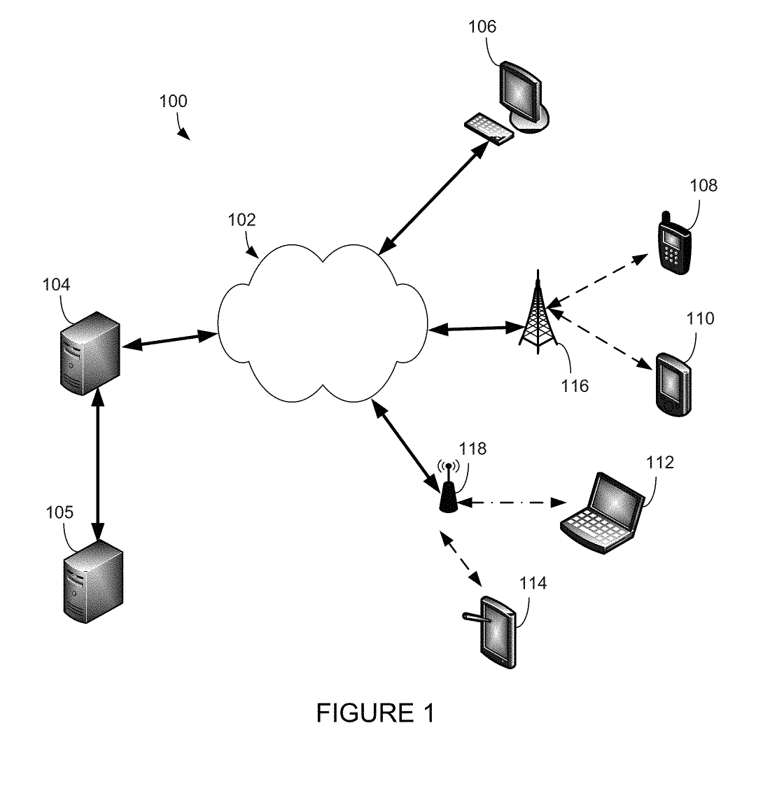

FIGS. 1 through 7, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

FIG. 1 illustrates an example computing system 100 according to this disclosure. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The network 102 facilitates communications between at least one server 104 and various client devices 106-114. Server 104 includes any suitable computing or processing device that can provide computing services for one or more client devices. Server 104 could, for example, include one or more processing devices, one or more memories storing instructions and data, and one or more network interfaces facilitating communication over the network 102.

As will be discussed below, at least one server 105 provides media information in the form a hypertext markup language (HTML) version 5 (HTML5) document and Motion Picture Experts Group (MPEG) Composition Information (CI). The HTML5 document provides an initial spatial layout and initial media elements for the playback of media. The CI contains timed instructions to control the media presentation layer to drive the presentation and synchronize its components.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

As described in more detail below, the client devices 106-114 may be used to access content on the server 105 via server 104.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

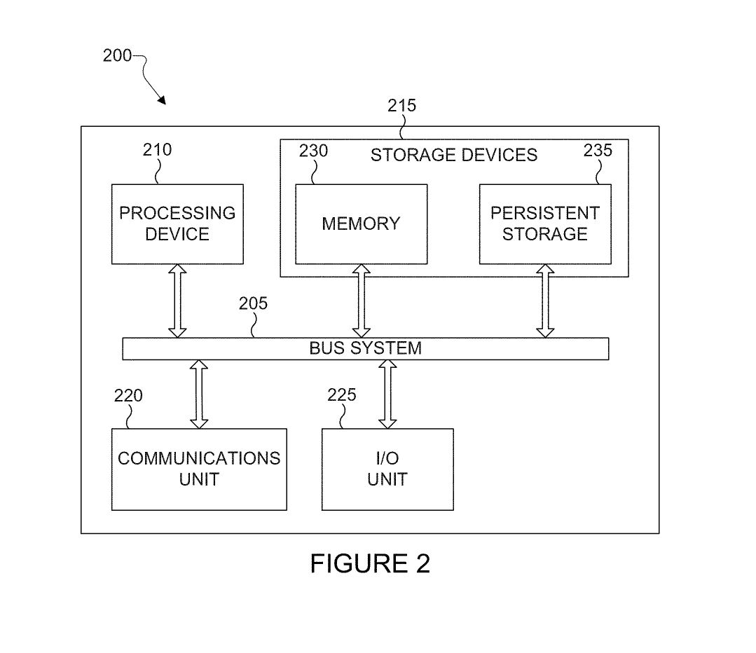

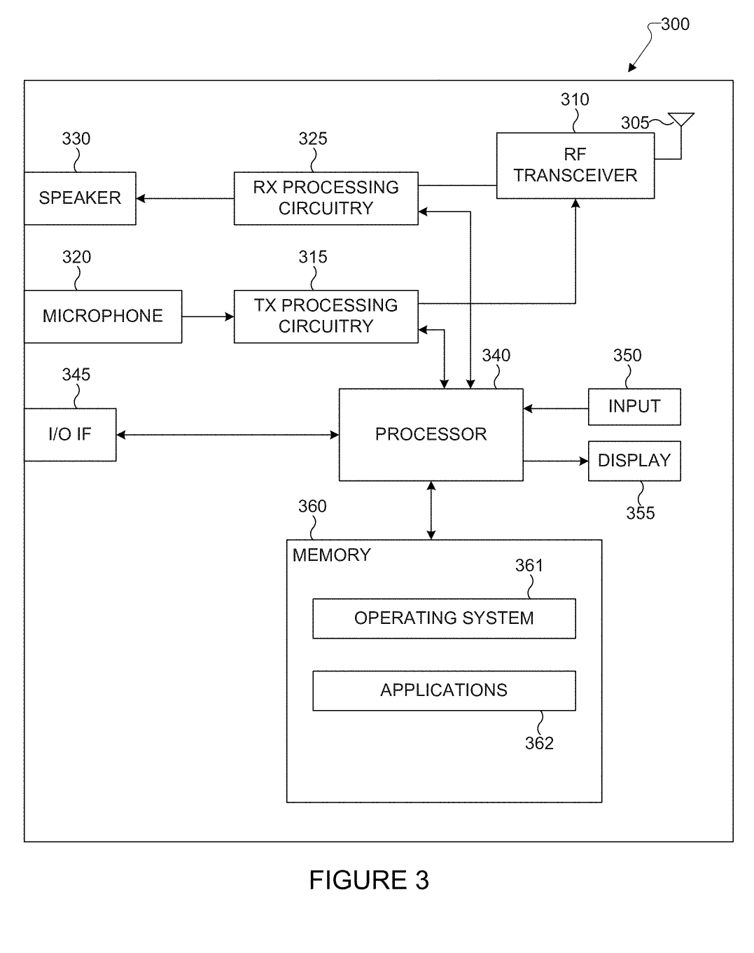

FIGS. 2 and 3 illustrate example devices in a computing system according to this disclosure. In particular, FIG. 2 illustrates an example server 200, and FIG. 3 illustrates an example client device 300. The server 200 could represent the server 104 or server 105 in FIG. 1, and the client device 300 could represent one or more of the client devices 106-114 in FIG. 1.

As shown in FIG. 2, the server 200 includes a bus system 205, which supports communication between at least one processing device 210, at least one storage device 215, at least one communications unit 220, and at least one input/output (I/O) unit 225.

The processing device 210 executes instructions that may be loaded into a memory 230. The processing device 210 may include any suitable number(s) and type(s) of processors or other devices in any suitable arrangement. Example types of processing devices 210 include microprocessors, microcontrollers, digital signal processors, field programmable gate arrays, application specific integrated circuits, and discreet circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a ready only memory, hard drive, Flash memory, or optical disc.

The communications unit 220 supports communications with other systems or devices. For example, the communications unit 220 could include a network interface card or a wireless transceiver facilitating communications over the network 102. The communications unit 220 may support communications through any suitable physical or wireless communication link(s).

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Note that while FIG. 2 is described as representing the server 104 or server 105 of FIG. 1, the same or similar structure could be used in one or more of the client devices 106-114. For example, a laptop or desktop computer could have the same or similar structure as that shown in FIG. 2.

In the embodiments described herein, server 105 provides an HTML5 document and a CI document for a presentation that may be reproduced by a client device 300. The server 105 may also provide updated CI documents to the client device 300. The server 105 may mark each CI document with a timestamp thereby permitting the client device 300 to use the latest update for a CI document.

As shown in FIG. 3, the client device 300 includes an antenna 305, a radio frequency (RF) transceiver 310, transmit (TX) processing circuitry 315, a microphone 320, and receive (RX) processing circuitry 325. The client device 300 also includes a speaker 330, a processor 340, an input/output (I/O) interface (IF) 345, an input 350, a display 355, and a memory 360. The memory 360 includes an operating system (OS) program 361 and one or more applications 362.

The RF transceiver 310 receives, from the antenna 305, an incoming RF signal transmitted by another component in a system. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS program 361 stored in the memory 360 in order to control the overall operation of the client device 300. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS program 361 or in response to signals received from external devices or an operator. The processor 340 is also coupled to the I/O interface 345, which provides the client device 300 with the ability to connect to other devices such as laptop computers and handheld computers. The I/O interface 345 is the communication path between these accessories and the processor 340.

The processor 340 is also coupled to the input 350 and the display unit 355. The operator of the client device 300 can use the input 350 to enter data into the client device 300. For example, the input 350 may be a touchscreen, button, and/or keypad. The display 355 may be a liquid crystal display or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

As described in more detail below, the client device 300 may receive presentation information, such as an HTML5 document and one or more CI documents from server 105 to reproduce a presentation.

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the client device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or server.

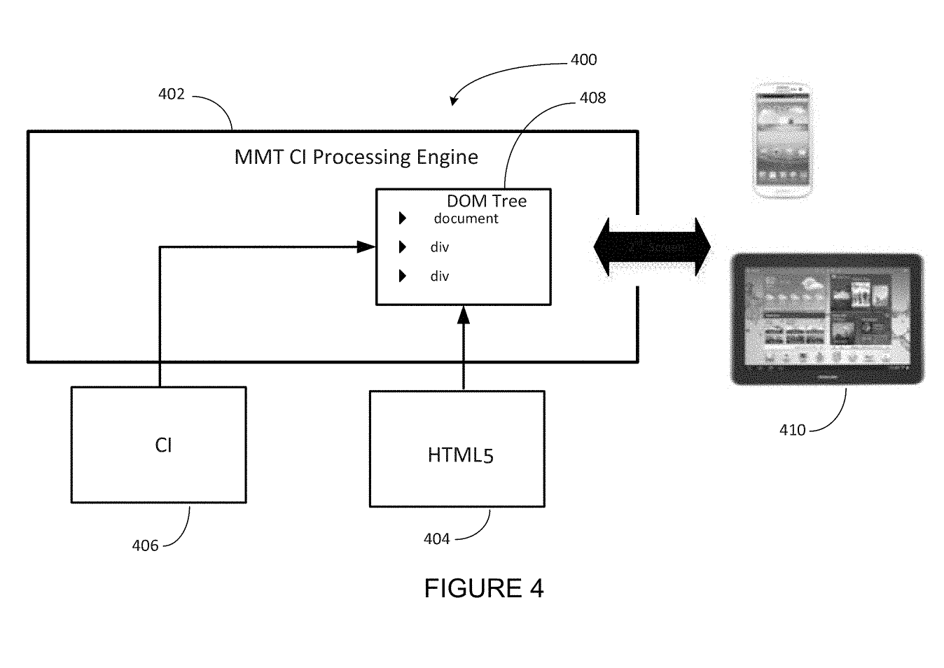

FIG. 4 illustrates a system 400 for processing presentation information according to this disclosure. As shown in FIG. 4, a MPEG media transport (MMT) CI processing engine 402, which may be incorporated in processor 340, receives presentation information as an HTML5 document 404 and a CI document 406. The HTML5 document 404 and the CI document 406 may be received, directly or indirectly from a server such as server 105 of FIG. 1. HTML5 document 404 provides the initial spatial layout and initial media elements for the playback of media. The CI document 406 contains timed instructions to control the media presentation layer to drive the presentation and synchronize the various components, such as video, audio, and subtitles. The CI document 406 is in the form of extensible markup language (XML) document and includes a MediaSync element, a sourceList element, and a mediaSrc element. The MediaSync element supports the following operations: provide a list of service components that will be played simultaneously; provide a list of media sources that represent alternatives with a priority based on order of appearance in the list; and provide a list of sources that need to be played back sequentially based on their start time. The MMT CI processing engine 402 is responsible for obtaining the HTML5 document 404 and the CI document 406 via push or pull methods.

The HTML5 document 404 is parsed into a document object model (DOM) tree and stored in a memory, such as memory 360. The MMT CI processing engine 402 applies changes to the DOM at specified time(s) according to the instructions provided by the CI document 406. The MMT CI processing engine 402 displays the presentation information on the display 410 based on the DOM.

The CI document 406 includes at least one of an indication that certain MediaSync elements are conditional, an indication of a transmission schedule of every MediaSync element that fits the different schedules of the presentation playback, and/or an indication to store MediaSync elements for a certain period of time for later playback.

As will be described below, a MediaSync element may be marked for conditional playback. The client device, e.g., client device 300, that supports conditional playback and also support the condition type, evaluates the condition to verify if it has to play the content or not. All MediaSync elements that are marked as belonging to the same condition group shall result in the selection of at most one MediaSync element. A MediaSync element that only shows the conditionGroup attribute shall be treated as the default MediaSync for that condition group and shall be played by the user agent if none of the previous MediaSync elements of the same condition group was selected for playback. The condition scripting language may be indicated by the conditionType attribute that defaults to “text/javascript” if not present. Additionally, an earliestPlayout and store attributes may also be included in the CI document to inform senders and receivers about potential skews in delivery and playback schedules as a consequence of the conditional playback.

The term condition refers to a statement that the client device will evaluate to determine if the content of the MediaSync element are to be played back or not. The condition must evaluate to a Boolean value, where true means that the content shall be played back and false means that it shall not be played back. ConditionGroup refers to the group to which a condition belongs to. If a MediaSync element indicates no condition but provides a conditionGroup, then the client device shall assume that this MediaSync element shall be played back by default if none of the MediaSync elements that share that same condition group is played back.

ConditionType refers to the scripting language that is used to specify the condition. The default value is “text/javascript”, which indicates ECMAScript. EarliestPlayout provides an indication to the sender that the content described by the current MediaSync element may be played back earlier by some of the client devices because of some earlier conditional playback content that was skipped.

In some embodiments, the MediaSync element or the sourceList element of the MPEG CI document 406 contains an indication that the playback of a specific media resource by the MediaSync element or the sourceList element is to be played back conditionally. In some embodiments, the condition is provided as a Javascript expression that evaluates to a Boolean true or false, wherein the playback of the specific media resource is only made in case the condition evaluates to true. The condition could be provided as an attribute of either the MediaSync element or the sourceList element. If provided on the MediaSync element and the condition evaluates to false, then the next MediaSync is to be played back and the current MediaSync element is skipped. If the next MediaSync element has a start time, then no content is to be shown until the indicated start time of the next MediaSync element.

The condition may be provided as a call to a function such as “checkPlayback” and passed an argument that identifies the conditional content. In addition, a “conditionGroup” attribute may be provided to group a set of mutually exclusive conditions or instructions. The last element that contains an indication of the same “condition Group” may omit the condition attribute, in which case it becomes the default if none of the previous conditions of that same “condition Group” evaluates to true.

In some embodiments, an indication of the earliest presentation time of a media resource is provided. This indication can, for example, be associated with every media processing unit (MPU) and be provided as part of the MediaSync element. This informs the sender that this element may be presented by some users at an earlier time than the indicated playback time. This is necessary for the case that a condition for a MediaSync element that does not evaluate to true results in content that is skipped and the content of the next MediaSync will played back earlier by some clients. This may be necessary for broadcast content where clients do not request content directly from the server.

In some embodiments, a store directive is also provided for the case that some media resources are delivered earlier than their presentation time for users that did not skip prior content. The store directive informs the client to keep the content in local cache for at least the indicated media duration as it will be needed for playback later.

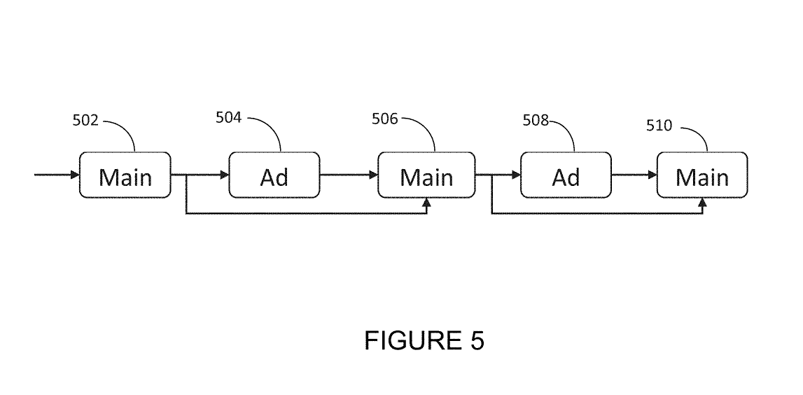

FIG. 5 illustrates different scenarios for reproducing presentation information according to this disclosure. As shown in FIG. 5, the client device 300 receives a number of MediaSync elements 502-510. MediaSync elements 504 and 508 include an indication that playback of the MediaSync element is conditional. Such conditions may include whether the user is male or female, a paying subscriber or non-paying subscriber, a regular subscriber or premium subscriber. Other conditions may include geographical conditions or temporal conditions. If a particular condition for MediaSync element 504 is evaluated as “true”, then MediaSync element 504 will be played back while if a particular condition for MediaSync element 508 is evaluated as false, then MediaSync element 508 will be skipped and MediaSync element 510 will be played back.

Because MediaSync elements 506 and 510 follow conditional MediaSync elements, each of MediaSync elements 506 and 510 include an indication of the store directive and the earliest presentation directive that corresponds to the preceding MediaSync elements 504 and 508, respectively, in case MediaSync elements 504 and/or 508 are not played back.

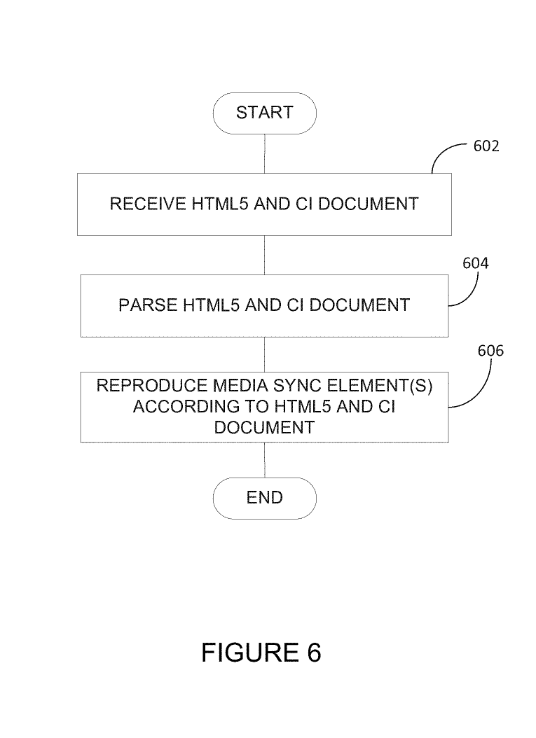

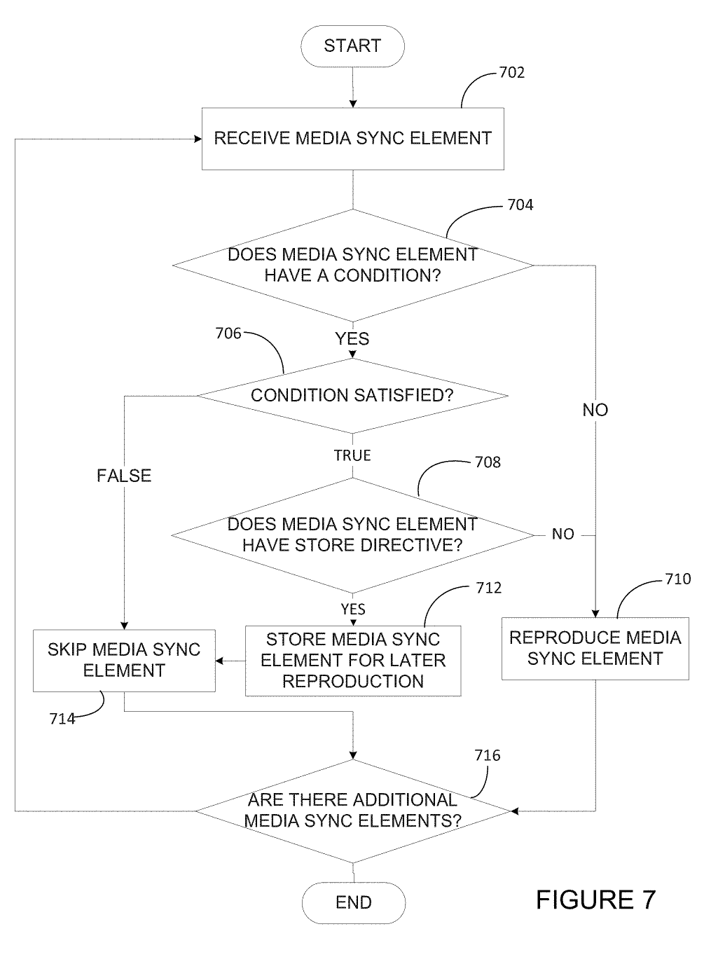

FIGS. 6 and 7 illustrate methods for reproducing MediaSync elements, such as MediaSync elements 502-510 of FIG. 5. As shown in FIG. 6, a MMT CI processing engine 402 receives HTML5 documents and CI documents in operation 602. The MMT CI processing engine 402 may obtain the documents via a push or pull method.

In operation 604, the MMT CI processing engine 402 parses the HTML 5 document and the CI document. The parsed HTML5 document provides a spatial layout and an initial MediaSync element to be reproduced. The parsed HTML5 document is stored as a document object model (DOM). The CI document includes at least one of an indication that certain MediaSync elements are conditional, an indication of a transmission schedule of every MediaSync element, and/or an indication to store MediaSync elements.

In operation 606, the MMT CI processing engine 402 reproduces the MediaSync element(s) according to a spatial layout provided by the HTML 5 document and the timing instructions provided by the CI document. Operation 606 will be discussed in more detail with regard to FIG. 7 which illustrates a method for reproducing the MediaSync elements in accordance with this disclosure.

As shown in FIG. 7, which will be discussed in conjunction with client device 300 of FIG. 3, a MediaSync element, e.g., MediaSync element 502, is received in operation 702 by processor 340.

In operation 704, the processor 340 determines if the MediaSync element has a condition based on the CI document received in operation 602. If there is no condition, the method proceeds to operation 710 where the MediaSync element is reproduced. If the MediaSync element includes a condition, the processor 340 determines whether the condition is satisfied in operation 706. If the processor 340 determines that the condition is evaluated as False, the MediaSync element is skipped in operation 714. If the processor 340 determines that the condition is evaluated as TRUE, the MediaSync element is reproduced the method proceeds to operation 708 where the processor 340 determines whether the MediaSync element has a store directive based on the CI document received in operation 602. If the MediaSync element has a store directive, the method proceeds to operation 712 where the MediaSync element is stored, e.g., in memory 360. If the MediaSync element does not have a store directive, the method proceeds to operation 710.

In operation 716, a determination is made as to whether there are additional MediaSync elements. The determination may be made by the processor 340 based on the CI document received in operation 602. If there are additional MediaSync elements, the method returns to operation 702. If there are no MediaSync elements, the method is ended.

Although FIG. 7 is described as processing one MediaSync element at a time, multiple MediaSync elements may be processed simultaneously by the processor 340 according to the method of FIG. 7. For example, a video MediaSync element, an audio MediaSync element, and subtitle MediaSync element may be processed and reproduced simultaneously.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. §112(f).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user equipment (UE) for reproducing a presentation having a plurality of media, the UE comprising:
a processor configured to:
receive a first document configured to provide the presentation and at least one second document configured to indicate a timing sequence for media and spatial layout updates;
determine whether the second document includes at least one condition for at least one instruction element among the plurality of instructions; and
reproduce the plurality of instructions in accordance with the first document, the second document, and/or the at least one condition;
a memory, wherein the second document includes a store directive for at least one instruction among the plurality of instructions and at least one media is stored in the memory based on the store directive; and
a display configured to display the presentation according to the reproduced plurality of instructions.

2. The UE of claim 1, wherein the at least one condition of the at least one instruction of the second document is a javascript function call that evaluates to true or false, and wherein true means execute the instruction and false means skip the instruction.

3. The UE of claim 1, wherein the second document includes a plurality of conditions corresponding to a plurality of instructions.

4. The UE of claim 3, wherein the plurality of conditions are grouped as a set of exclusive instructions.

5. The UE of claim 1, wherein the at least one instruction from the second document is assigned to one group.

6. The UE of claim 5, wherein at most one instruction from the one group is executed by the processor.

7. The UE of claim 1, wherein the second document includes a time associated with the at least one instruction element, wherein the time provides an indication of the earliest time that the at least one instruction element may be reproduced.

8. A server comprising:
a processor configured to generate a first document configured to provide a presentation and at least one second document including at least one condition for at least one instruction for a media element; and
a transceiver configured to transmit the first document and the second document to a user equipment (UE)
wherein the second document includes a time associated with the at least at least one instruction, the time provides an indication of the earliest time that the media element may be reproduced.

9. The server of claim 8, wherein the second document includes a plurality of conditions corresponding to a plurality of instruction elements.

10. The server of claim 9, wherein the plurality of conditions are grouped as a set of exclusive instructions.

11. The server of claim 8, wherein the second document includes a store directive in at least one instruction for the media element.

12. The server of claim 8, wherein the second document is configured to indicate a timing sequence for a plurality of media included in the presentation.

13. The server of claim 12, wherein the plurality of media may include one or more video elements, audio elements, and/or subtitle elements.

14. The server of claim 8, wherein the processor is further configured to mark the second document with a time stamp.

15. A method for reproducing a presentation in an electronic device having a processor and a display, the method comprising:
receiving, in the processor, a first document configured to provide a the presentation and at least one second document configured to indicate a timing sequence for a plurality of media and spatial layout updates included in the presentation;
determining whether the second document includes at least one condition for at least one instruction element among a plurality of instructions;
reproducing, by the processor, the plurality of instructions in accordance with the first document, the second document, and/or the at least one condition; and
displaying the presentation according to the reproduced plurality of instructions.

16. The method of claim 15, wherein the second document includes a plurality of conditions corresponding to a plurality of instructions.

17. The method of claim 16, the plurality of conditions is grouped as a set of exclusive instructions.

18. The method of claim 15, wherein reproducing the plurality of media comprises:
determining whether at least one media among the plurality of media includes a store directive; and
storing the at least one media in a memory of the electronic device if the at least one media includes a store directive.

19. The method of claim 15, wherein reproducing the plurality of instructions comprises:
determining whether the electronic device satisfies the condition,
wherein, if the condition is satisfied, the at least one instruction element is executed, and
wherein, if the condition is not satisfied, at least one instruction element is not executed.

20. The method of claim 15, wherein the plurality of media may include one or more video elements, audio elements, and/or subtitle elements.
